(19) United States
(12) Patent Application Publication
(10) Pub. No.: US 2003/0212158 A1
(43) Pub. Date: Nov. 13, 2003

(54) Method of using cyclic organic carbonates as additives in the production of polyurethane foams

(76) Inventors: Georg Burkhart, Essen (DE); Manfred Klincke, Castrop-Rauxel (DE); Andreas Weier, Essen (DE)

Correspondence Address: FROMMER LAWRENCE & HAUG, 745 FIFTH AVENUE- 10TH FL., NEW YORK, NY, 10151, US

(21) Appl. No.: 10/426,586

(22) Filed: Apr. 30, 2003

Related U.S. Application Data
(63) Continuation of application No. 09/146,863, filed on Sep. 3, 1998, now abandoned.

(30) Foreign Application Priority Data
Sep. 6, 1997 (DE) 197 39 009.9

(51) Int. Cl. C08K 3/00; C08J 9/00; C08G 18/00

(52) U.S. Cl. 521/99

(57) ABSTRACT

The invention relates to the use of cyclic organic carbonates as additives in formulations for the production of polyurethane foams.

### RELATED APPLICATIONS

This application claims priority to German application No. 197 39 009.9, filed Sep. 6, 1997, herein incorporated by reference

### BACKGROUND OF THE INVENTION

1. Field of the Invention

The invention relates to the use of carbonates as additives in formulations for the production of polyurethane foams.

2. Background of the Invention

Polyurethane foams are employed in a wide range of applications, both as structural elements and for fulfilling a wide range of industrial tasks. The industry distinguishes polyurethane foams on the basis of the polyol raw material used as reaction component for the isocyanate employed in the process. Hence, the industry distinguishes between polyether-polyurethane foams and polyester-polyurethane foams.

From a structural point of view, it is also possible to make a distinction between rigid foams and flexible foams. Rigid foams are usually used as insulation materials or as structural units. Flexible foams, owing to their elastic properties, are used in areas such as the furniture sector.

Traditionally physical blowing agents such as CFCs, HCFCs, etc. have been used for the production of polyurethane foams. However, because of the ever-increasing environmental regulations, these blowing agents, which have long been used for the production of polyurethane foams, have lost their attractiveness as auxiliaries having a future in the production of flexible polyurethane foams. Accordingly, attempts have been made to produce some types and grades of foam using alternative blowing agents such as acetone, methylene chloride or pentane.

3. Description of the Related Art

One technology which has been developed uses, as a blowing gas, a pressurized inert gas, in addition to the CO₂ formed during chemical reaction of the isocyanates with water. An example of such a gas is CO₂. This technology is described, for example, in EP-A-0 645 226, herein incorporated by reference. The spontaneous foaming of the pressurized CO₂ on discharge of the reaction mixture places increased demands on the cell-forming characteristics of the components used in the foam formulation. The increased demand on the cell foaming characteristics can also be explained by the spontaneous foaming in contrast to the isocyanate-water reaction, which commences slowly over a period of time of several seconds and leads only to a slow saturation of the liquid phase with gas and thus to the slow formation of gas bubbles. This formation of gas is called creaming.

This process forms the basis for morphological properties, viz. cell count and cell size distribution, of the foam formed. This previous slow process is now compressed into fractions of a second, namely the time which the raw materials take to go from the pressurized mixing head of a foaming machine and the subsequent lay down device to the ambient atmospheric pressure. In this situation, a foam is formed spontaneously by vaporization of liquid CO₂, similar to that which occurs in the case of shaving foam from a spray can. Defects in the form of non-uniform, sometimes enlarged cells within the foam structure occurred in the case of such foams. The use of suitable foam stabilizers can be very useful in minimizing these defects.

Nevertheless, frequently there is the problem that even stabilizers, which are well suited to processes according to the present state of the art, do not produce completely defect-free foams. Such prior art stabilized are described, for example, in U.S. Pat. No. 5,357,018 or U.S. Pat. No. 5,321,051, both herein incorporated by reference.

### OBJECT OF THE INVENTION

Accordingly, it is an object of this invention to produce polyurethane foams which exhibit a significant improvement in the cell structure of the foam.

Surprisingly, it has been discovered that a significant improvement in the cell structure of the polyurethane foams occurs when cyclic organic carbonates are used in the production process. This improvement is most apparent in critical formulations or in producing foams which use liquid, pressurized inert gases.

Presently, organic carbonates are employed in a number of polyurethane foams as a viscosity-reducing additive in the blowing reaction. Examples of such foams are the rigid polyurethane foams which are described, inter alia, in U.S. Pat. No. 5,102,923, incorporated herein by reference. Additionally, it has been known in the art to use organic carbonates as solvents (e.g. in U.S. Pat. No. 4,028,299 as compatibilizer, incorporated herein by reference) or reactive diluents in 2-component urethane systems.

A considerable part of the literature concerning rigid polyurethane foams addresses the issue of using carbonates as blowing agent in which CO₂ is liberated. Analogous to the time of CO₂ release in the water-isocyanate reaction, the liberation of CO₂ in this case occurs rather late in the foaming process (U.S. Pat. No. 5,076,959 or U.S. Pat. No. 5,346,928, both incorporated by reference). In U.S. Pat. No.5,346,928, isocyanate-reactive cyclic carbonates are used as blowing promoter in rigid foams. In the case of these blowing promoters, the use of an inert insoluble, organic liquid, which is present as dispersed phase of an emulsion or rmicro-emulsion, influences the fine cell size of the rigid foams formed. In this case too, the organic carbonates are thus employed as auxiliaries in the blowing reaction or, owing to their emulsifying properties, to emulsify the insoluble organic liquid employed.

In flexible block foams, organic carbonates have been used as additives, particularly in flame-resistant foams. The organic carbonates were sometimes added to reduce the scorching which occurs in very hot foams (in U.S. Pat. No. 4,621,105 or EP-A-0 582 328, herein incorporated by reference). In U.S. Pat. No. 4,071,482, herein incorporated by reference, organic carbonates have been used in flame-resistant foams for increasing the brittleness of the foams formed. On the basis of experience, it should be noted that, the rougher or more brittle a foam feels, the coarser or more closed the cell structure.

### SUMMARY OF THE INVENTION

Surprisingly, it has been discovered that the use of cyclic organic carbonates in the preparation of polyurethane foam formulations, in general, and in flexible polyether-polyurethane foam formulations, in particular, produces an unexpected effect on the fineness and the uniformity of the cells formed. Particularly, this effect occurs in formulations which display a comparatively high tendency for forming irregular or partially coarsened foam structures either as a result of the raw materials used or when the foaming steps are carried out under unusual pressure conditions. These circumstances include situations where compounds such as pure polypropylene glycols are used as the polyol component as well as where the formulation constituents are exposed to reaction conditions such as large pressure drops during the course of foaming. Such large pressure drops occur, for example, when foaming is carried out using liquid, pressurized inert blowing agents.

### DESCRIPTION OF THE PREFERRED EMBODIMENTS

Suitable cyclic carbonates are those of the formula

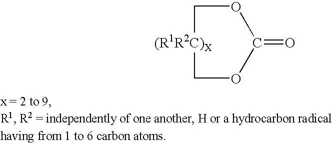

Preference is given to cyclic carbonates in which x=2 to 3; particular preference is given to propylene carbonate and ethylene carbonate.

### EXAMPLES

A flexible polyurethane foam was produced in a 27×27 cm open wooden box having a wall height of 27 cm by foaming a polyurethane formulation comprising the following constituents:

100 parts of a trifunctional polypropylene glycol having an OH number of 56,

4.05 parts of water,

0.2 part of a tertiary amine catalyst,

0.2 part of tin octoate,

3.0 parts of a physical blowing agent

and a 1.12-fold molar amount, based on the hydroxyl groups present in the formulation, of isocyanate groups in the form of the 80:20 mixture of the 2,4 and 2,6 isomers of tolylene diisocyanate, known as T80.

A silicone-polyether copolymer known as BC 2555, obtainable by hydrosilylation of Si—H-containing siloxanes using allyl-initiated polyethers and corresponding to an Si—C stabilizer as described, for example, in U.S. Pat. No. 5,321,051, incorporated herein by reference, was used as foam-stabilizing agent to stabilize the foams formed. In the examples according to the invention, this stabilizer was mixed with small amounts of organic carbonates while, in the comparative experiments which were not according to the invention, the pure product or a mixture with components which are not according to the invention, was employed. After curing the foam, the foam body obtained was cut horizontally and the cell structure found on the cut surface was evaluated at a height of 15 cm above the bottom of the foam. Evaluation criteria employed were both the number of cells/cm and the regularity of the cell structure obtained. In addition, the pressure build-up which results in a circular feed line having a diameter of 2 cm on passing 8 liters per minute through the foam specimen was measured as a measure of the open-cell content of the foams obtained. The lower the measured pressure build-up the more open-celled the foam obtained. The following results were obtained:

| Concentration | | Concentration | | Cell fineness | Pressure |
|---|---|---|---|---|---|
| of BC 2555 | | of diluent | Cell | [No. of cells | build-up |
| [pphp] | Additive | [pphp] | structure | per cm] | [mm of water] |
| 0.38 | none | — | slightly | 6 | 80 |
| | | | irregular | | |
| 0.38 | dipropylene | 0.22 | slightly | 6-7 | 300 |
| | glycol | | irregular | | |
| 0.38 | propylene | 0.22 | regular | 14 | 27 |
| | carbonate | | | | |
| 0.38 | ethylene | 0.22 | regular | 12 | 34 |
| | carbonate | | | | |
| 0.38 | dimethyl | 0.22 | slightly | 4 | 232 |
| | carbonate | | irregular | | |
| 0.5 | none | — | regular | 7-8 | 292 |
| 0.5 | dipropylene | 0.3 | virtually | 7 | 125 |
| | glycol | | regular | | |
| 0.5 | propylene | 0.3 | regular | 14 | 35 |
| | carbonate | | | | |
| 0.5 | ethylene | 0.3 | regular | 12 | 81 |
| | carbonate | | | | |
| 0.5 | dimethyl | 0.3 | regular | 4-5 | 234 |
| | carbonate | | | | |

The data clearly demonstrate that the use of cyclic organic carbonates as component in flexible foam formulations or as component of a foam stabilizer produces an unexpected, positive effect on the fine cellularity and regularity of the polyurethane foams obtained.

This effect was also demonstrated in machine tests using liquid, pressurized inert gases as blowing agents (corresponding to the CarDio® or Novaflex™ processes). In these experiments, a formulation comprising 4.8 parts of water and 4.0 parts of carbon dioxide was foamed in a CarDio® unit. In each case, a highly active stabilizer corresponding to EP-A-0 585 771, herein incorporated by reference, was used as stabilizer. The example according to the invention utilized propylene carbonate as component in the stabilizer. The comparative example, which is not according to the invention, replaced the proportion of propylene carbonate with dipropylene glycol. Subsequently, the cell structure of the foam obtained was assessed and classified according to the scale of defect-free, slightly disrupted, moderately disrupted, disrupted or very disrupted.

| Composition of the stabilizer mixture | Cell structure |
|---|---|
| 0.9 part of silicone-polyether copolymer and | moderately disrupted |
| 0.5 part of dipropylene glycol | |
| 0.9 part of silicone-polyether copolymer and | Slightly disrupted |
| 0.5 part of propylene carbonate | |

These data demonstrate that an improvement in the cell fineness occurred when propylene carbonate was used in a foaming process where liquid inert gases were used as blowing agent.

In a rigid foam formulation comprising 95 parts of polyol (OHN: 250), 5 parts of crosslinker (OHN: 1700), 1 part of water, 2.5 parts of a tertiary amine, 1 part of a commercial rigid foam stabilizer (Tegostab B 8450, obtainable from Th. Goldschmidt AG, Essen), 25 parts of HCFC 141b and polymeric MDI (Index 110), the effect of an addition of 5 parts of propylene carbonate was tested. In this case too, the results obtained demonstrate the unexpected effect according to the invention of the cyclic organic carbonates on the cell fineness of polyurethane foams.

| Composition of the stabilizer mixture | Cell structure |
|---|---|
| 1 part of silicone-polyether copolymer B8450 | 15-19 cells/cm |
| 1 part of silicone-polyether copolymer B8450 and | 21-25 cells/cm |
| 5 parts of propylene carbonate | |

The above description of the invention is intended to be illustrative and not limiting. Various changes or modifications in the embodiments described herein may occur to those skilled in the art. These changes can be made without departing from the scope or specification of the invention.

1. A process for preparing polyurethane foams which comprises adding a foam additive comprising a cyclic organic carbonate.

2. The process according to claim 1, wherein the cyclic carbonate is of the formula 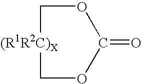
wherein
X is an integer from 2 to 9, and
R¹ and R² independently of one another is hydrogen or a hydrocarbon radical having from 1 to 6 carbon atoms.

3. The process according to claim 2, wherein X is 2 or 3.

4. The process according to claim 1, wherein the cyclic carbonate is ethylene carbonate or propylene carbonate.

5. The process according to claim 1, wherein the polyurethane foam is a flexible polyurethane foam.

6. A process for preparing polyurethane foams which comprises adding a pressurized inert gas as a blowing agent and a foam additive comprising a cyclic organic carbonate.

7. The process according to claim 6, wherein the cyclic carbonate is of the formula 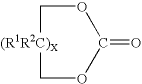
wherein
X is an integer from 2 to 9, and
R¹ and R² independently of one another is hydrogen or a hydrocarbon radical having from 1 to 6 carbon atoms.

8. The process according to claim 7, wherein X is 2 or 3.

9. The process according to claim 6, wherein the cyclic carbonate is ethylene carbonate or propylene carbonate.

10. The process according to claim 6, which the foam is a flexible polyether foam.

11. In a process for preparing a flexible polyurethane foam, the improvements which comprises adding a cyclic organic carbonate as a cell-regulating additive.

12. The process according to claim 11, wherein the cyclic carbonate is of the formula 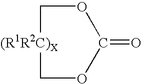
wherein
X is an integer from 2 to 9, and
R¹ and R² independently of one another is hydrogen or a hydrocarbon radical having from 1 to 6 carbon atoms.

13. The process according to claim 12, wherein X is 2 or 3.

14. The process according to claim 11, wherein the cyclic carbonate is ethylene carbonate or propylene carbonate.

15. A flexible foam formulation for the production of polyurethane foams which comprises a foam additive comprising a cyclic organic carbonate.

16. The formulation according to claim 15, wherein the cyclic organic carbonate is propylene carbonate or ethylene carbonate.

17. A rigid foam form formulation for the production of polyurethane foams, which comprises a cyclic organic carbonate.

18. The formulation according to claim 17, wherein the cyclic organic carbonate is propylene carbonate or ethylene carbonate.

19. A foam additive mixture comprising a cyclic organic carbonate and a stabilizer agent.

20. The foam additive mixture according to claim 19, wherein the stabilizing agent is a silicone-containing stabilizing agent.

21. The foam additive mixture according to claim 19, wherein the cyclic carbonate is of the formula 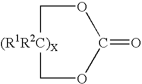
wherein
X is an integer from 2 to 9, and
R¹ and R² independently of one another is hydrogen or a hydrocarbon radical having from 1 to 6 carbon atoms.

22. The foam additive mixture according to claim 21, wherein X is 2 or 3.

23. The foam additive mixture according to claim 19, wherein the cyclic carbonate is ethylene carbonate or propylene carbonate.

24. In a process for preparing polyurethane foams the improvement which comprises adding a pressurized inert gas as a blowing agent and adding a foam additive mixture according to claim 19.

25. The process according to claim 24, wherein the inert gas is CO₂.
